(19) United States
(12) Patent Application Publication
(10) Pub. No.: US 2008/0236968 A1
(43) Pub. Date: Oct. 2, 2008

(54) HYDRAULIC BUFFERING APPARATUS

(76) Inventor: Akimi Watanabe, Saitama (JP)

Correspondence Address: BIRCH STEWART KOLASCH & BIRCH, PO BOX 747, FALLS CHURCH, VA, 22040-0747, US

(21) Appl. No.: 12/042,466

(22) Filed: Mar. 5, 2008

(30) Foreign Application Priority Data
Mar. 29, 2007 (JP) 2007-086637

(51) Int. Cl. F16F 9/14

(52) U.S. Cl. 188/313

(57) ABSTRACT

A hydraulic buffering apparatus in which an impact from the road surface is alleviated even when the impact due to high-frequency vibrations are generated, so that the ride quality of a vehicle is improved. A piston is provided in a cylinder for partitioning the interior of the cylinder into a rod-side oil chamber on the side of a piston rod and a counter-rod-side oil chamber. The two oil chambers are in communication with each other via a pair of ports provided on the piston. Damping valves are respectively provided at exit ends of the pair of ports respectively so as to be openable and closable. A supporting member holds the piston and the damping valves. The supporting member is slidably arranged on a shaft of the piston rod and is held between stoppers provided on the shaft of the piston rod via resilient members.

### CROSS-REFERENCE TO RELATED APPLICATIONS

The present application claims priority under 35 USC 119 to Japanese Patent Application No. 2007-086637 filed on Mar. 29, 2007 the entire contents of which are hereby incorporated by reference.

### BACKGROUND OF THE INVENTION

1. Field of the Invention

The present invention relates to a hydraulic buffering apparatus suitable for using generally for hydraulic buffering apparatuses such as a front fork and a rear shock absorber, that is interposed between a vehicle body side and a wheel side in a motorcycle for absorbing an impact from the road surface.

2. Description of Background Art

In the related art, a hydraulic buffering apparatus such as a rear shock absorber is provided between the vehicle body side and the rear wheel side of a vehicle such as a motorcycle, so that an impact such as vibrations or the thrust input from the road surface during travel is damped to improve the ride quality of the vehicle.

As a hydraulic buffering apparatus of this type, there is proposed one in which a piston provided in a cylinder partitions the interior of the cylinder into a rod-side oil chamber on the side of the piston rod and a counter-rod-side oil chamber. The two oil chambers are in communication with each other via an extension port and a compression port provided on the piston. An extension-side damping valve and a pressure-side damping valve are provided at exit ends of the extension port and the compression port so as to be openable and closable. See, for example, JP-A-2003-254375. In this configuration, oil in the rod-side oil chamber opens the extension-side damping valve by the extension port and flows out into the rod-side oil chamber so that an extension-side damping force is generated by the flowing resistance by the port and the extension-side damping valve when the piston rod is in an extension stroke. In the same manner, in a compression stroke, oil in the counter-rod-side oil chamber opens the pressure-side damping valve by the compression port and flows out into the rod-side oil chamber so that a pressure-side damping force is generated by the flowing resistance by the compression port and the pressure-side damping valve.

However, in the configuration in the related art, when an impact by high-frequency vibrations are generated in the motorcycle or the like according to the state of the road surface, the extension-side damping valve and the pressure-side damping valve may not generate an adequate damping force, so that the alleviation of the impact from the road surface cannot be achieved. Thus, the ride quality of the vehicle may be impaired.

### SUMMARY AND OBJECTS OF THE INVENTION

It is an object of an embodiment of the present invention to solve the problems described above in the related art and provide a hydraulic buffering apparatus in which an alleviation of impact from the road surface is achieved even when an impact is generated by, for example, high-frequency vibrations, so that the ride quality of the vehicle is improved.

According to an embodiment of the present invention, a hydraulic buffering apparatus is provided in which a piston is disposed in a cylinder so as to partition the interior of the cylinder into a rod-side oil chamber on the side of a piston rod and a counter-rod-side oil chamber. The two oil chambers are in communication with each other via a pair of ports provided on the piston. Damping valves are provided respectively at exit ends of the pair of ports so as to be openable and closable. A supporting member holds the piston and the damping valves and is slidably arranged on a shaft of the piston rod and is held between stoppers provided on the shaft of the piston rod via resilient members.

According to an embodiment of the present invention, even when an impact caused by high-frequency vibrations is entered to the hydraulic buffering apparatus according to the state of the road surface and, for example, a pair of the damping valves do not generate an adequate damping force any longer, the damping valves and the piston then reciprocate on the shaft of the piston rod by the action of inertia according to the total mass of the respective members integrally with the supporting member and finely vibrates thereon. The supporting member is integrally provided with the respective members colliding the resilient members on both sides thereof in response to the high-frequency vibrations. Thus, the supporting member is compressively deformed the same to obtain an adequate reaction force from the respective resilient members. Therefore, even when the impact caused by the high-frequency vibrations according to the state of the road surface is entered, an adequate reaction force is obtained from the respective resilient members, so that the ride quality of a vehicle is improved.

In this case, a configuration is provided in which the supporting member includes a cylindrical portion to be fitted on the shaft of the piston rod, the cylindrical portion includes a flange at one end thereof, the outer surface of the flange comes into abutment with a first resilient member and a first damping valve, the piston, a second damping valve, and a support of the second damping valve are arranged in sequence on a shaft of the cylindrical portion on the side of the inner surface of the flange so that the support is brought into abutment with a second resilient member is also applicable.

In this configuration, since the configuration in which the first damping valve, the piston, the second damping valve, and the support of the second damping valve are arranged in sequence on the shaft of the cylindrical portion which is fitted to the piston rod, so that the support is brought into abutment with the second resilient member is employed, the assembleability of the respective members is improved.

A configuration in which the support is formed on the inner peripheral portion thereof with a fitting hole to which the distal end of the cylindrical portion is fitted so as not to penetrate through the support. In addition, the distal end of the cylindrical portion being fitted into the fitting hole is also applicable.

In this configuration, since the fitting hole to which the distal end of the cylindrical portion is fitted is formed on the inner peripheral portion of the support so as not to penetrate through the support, and the distal end of the cylindrical portion is fitted to the fitting hole, the surface area of the support which comes into abutment with the second resilient member is increased correspondingly. Therefore, when the supporting member integrally including the respective members collides repeatedly to the resilient members on both sides thereof according to high-frequency vibrations, it comes into abutment with the second resilient member stably, so that an adequate reaction force is obtained from the second resilient member.

According to an embodiment of the present invention, even when an impact caused by high-frequency vibrations is entered and, for example, the pair of damping valves do not generate an adequate damping force any longer, the damping valve and the piston reciprocate on the shaft of the piston rod integrally with the supporting member and finely vibrate thereon and collide with the resilient members on both sides thereof, so that an adequate reaction force is obtained from the respective resilient members, whereby the ride quality of the vehicle is improved.

In addition, with a configuration in which the first damping valve, the piston, the second damping valve, and the support of the second damping valve are arranged in sequence on the shaft of the cylindrical portion to be fitted on the piston rod, and the support is brought into abutment with the second resilient member, assembleability of the respective members is improved.

Furthermore, when a fitting hole to which the distal end of the cylindrical portion is fitted is formed on the inner peripheral portion of the support so as not to penetrate through the support and the distal end of the cylindrical portion is fitted into the fitting hole, the surface area of the support which comes into abutment with the second resilient member is increased correspondingly. Therefore, when the supporting member integrally including the respective members collides repeatedly to the resilient members on both sides thereof in response to the high-frequency vibrations, it comes into abutment with the second resilient member stably, so that an adequate reaction force is obtained from the second resilient member.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a front view, partly in vertical cross section, of a hydraulic buffering apparatus according to an embodiment of the present invention;

FIG. 2 is a front view, partly in vertical cross section, of the hydraulic buffering apparatus in an extension stroke; and

FIG. 3 is a front view, partly in vertical cross section, of the hydraulic buffering apparatus in a compression stroke.

### DETAILED DESCRIPTION OF THE PREFERRED EMBODIMENTS

Referring now to the drawings, an embodiment of the present invention will be described.

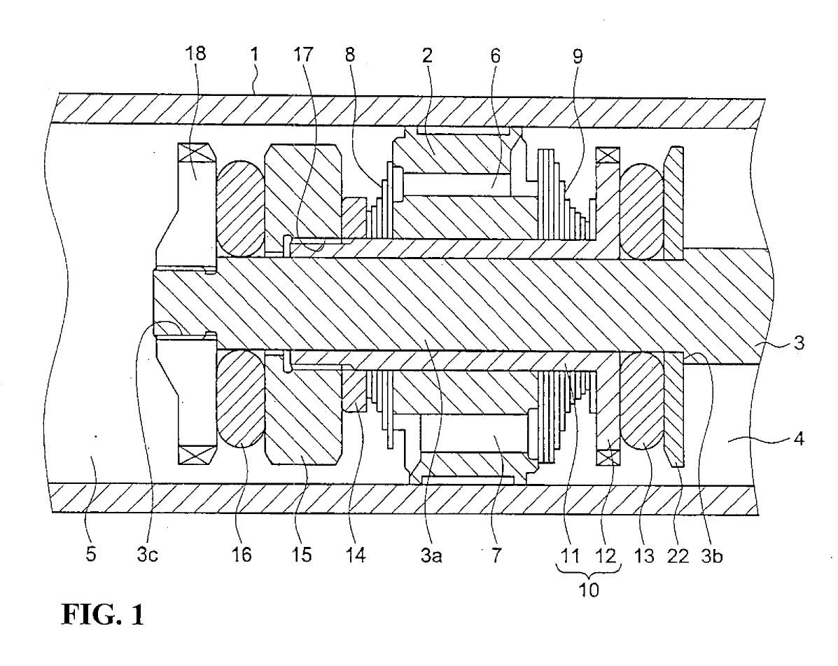

FIG. 1 to FIG. 3 are front views, partly in vertical cross section, of a hydraulic buffering apparatus.

In FIG. 1, a cylinder 1 constitutes a hydraulic buffer according to this embodiment. A piston 2 is provided in the interior of the cylinder 1, and a piston rod 3 is provided on the piston 2 so as to be movable in the cylinder 1 integrally with the piston 2. The piston 2 is a diaphragm for partitioning the interior of the cylinder 1, and a rod-side oil chamber 4 is defined on one side and a counter-rod-side oil chamber 5 is defined on the other side in the cylinder 1.

The piston 2 is provided with an extension port 6 and a compression port 7 which communicate the two oil chambers 4, 5 with each other. An extension-side damping valve (second damping valve) 8 and a pressure-side damping valve (first damping valve) 9, each having a plurality of leaf valves having different outer diameters in piles are provided at respective exit ends of the extension port 6 and the compression port 7 so as to be openable and closable, respectively.

In this configuration, two valves, that is, the extension-side damping valve 8 and the pressure-side damping valve 9 are provided. However, a configuration in which only one of the valves is provided is also applicable.

A thin portion 3a having a smaller diameter is formed at the distal end of the piston rod 3, and a supporting member 10 is fitted on the thin portion 3a so as to be capable of moving along the axis of the thin portion 3a. The supporting member 10 is provided with a cylindrical portion 11 which is fitted on the axis of the thin portion 3a, and the cylinder 11 is integrally formed with a collar-shaped flange 12 at one end thereof.

An annular first stopper 22, which is inserted until it comes into abutment with a shoulder 3b at the distal end of the piston rod 3, is fitted onto the thin portion 3a of the piston rod 3. Thereafter, an annular first resilient member 13 formed of resilient rubber is fitted thereon, so that the outer surface of the flange 12 is brought into abutment with the first resilient member 13. The annular pressure-side damping valve (first damping valve) 9 is fitted onto the shaft of the cylindrical portion 11 on the side of the inner surface of the flange 12 until it abuts against the inner surface of the flange 12, the aforementioned piston 2 is fitted thereon, the annular extension-side damping valve 8 (second damping valve) is fitted thereon, an annular first support 14 for holding the extension-side damping valve 8 is fitted on the shaft of the cylinder portion 11. Thereafter, the distal end of the cylindrical portion 11, which is passed through the first support 14, is connected to the inner peripheral surface of a second support (support) 15 via a thread.

More specifically, the inner peripheral portion of the second support 15 is formed with a fitting hole 17 to which the distal end of the cylindrical portion 11 is fitted so as not to penetrate through the second support 15 in the direction of the shaft hole. In addition, the distal end of the cylindrical portion 11 is connected to the fitting hole 17 via the thread. The second support 15 comes into abutment with an annular second resilient member 16 formed of resilient rubber which is fitted on the shaft of the thin portion 3a, and the second resilient member 16 is held between the second support 15 and a nut (stopper) 18 screwed on a thread 3c at the distal end of the thin portion 3a.

Subsequently, an operation according to this embodiment will be described.

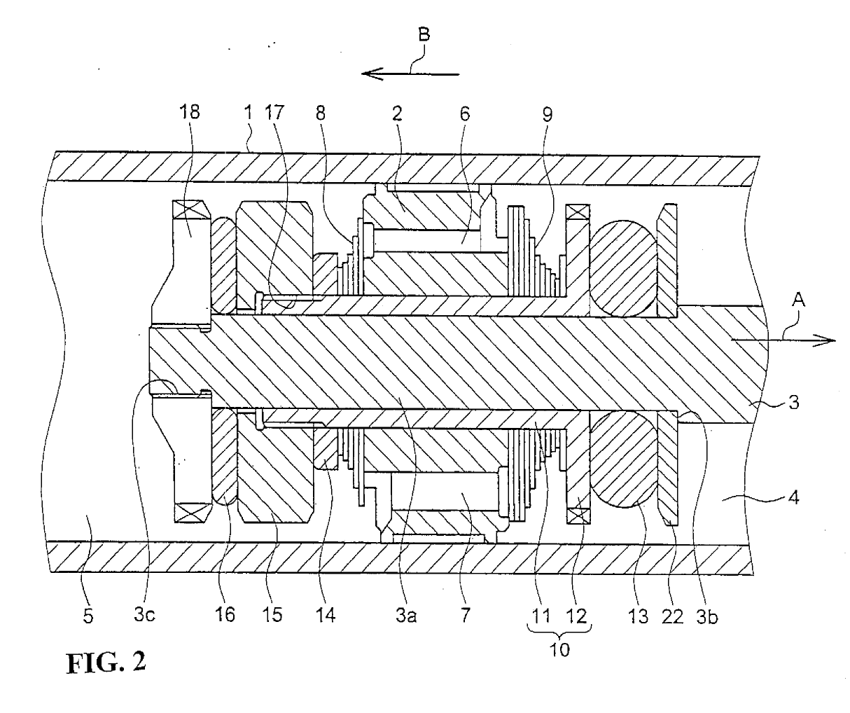

For example, when the piston rod 3 is used as an inverted hydraulic buffering apparatus which is connected to a front shock absorber, a rear shock absorber or the like of a motorcycle on the wheel side, the piston rod 3 is moved in the direction indicated by an arrow A in FIG. 2 in an extension stroke. Thus, oil in the rod-side oil chamber 4 pushes away the extension-side damping valve 8 to open the extension port 6, and flows out from the extension port 6 into the counter-rod-side oil chamber 5, so that an extension-side damping force is generated by the flowing resistance by the extension port 6 and the extension-side damping valve 8.

There may be a case in which the opening of the extension-side damping valve 8 is delayed with respect to an instantaneous and impulsive input when the shock absorber is in action. In this case as well, the piston 2, the respective valves 8, 9 and the respective supports 14, 15 move in the direction indicated by an arrow B in FIG. 2 integrally with the support member 10 by the action of inertia according to the total mass thereof, and the second support 15 compresses the second resilient member 16 while the valve 8 opens to an adequate opening degree, so that an adequate reaction force is obtained by the second resilient member 16, whereby the ride quality of a vehicle is improved.

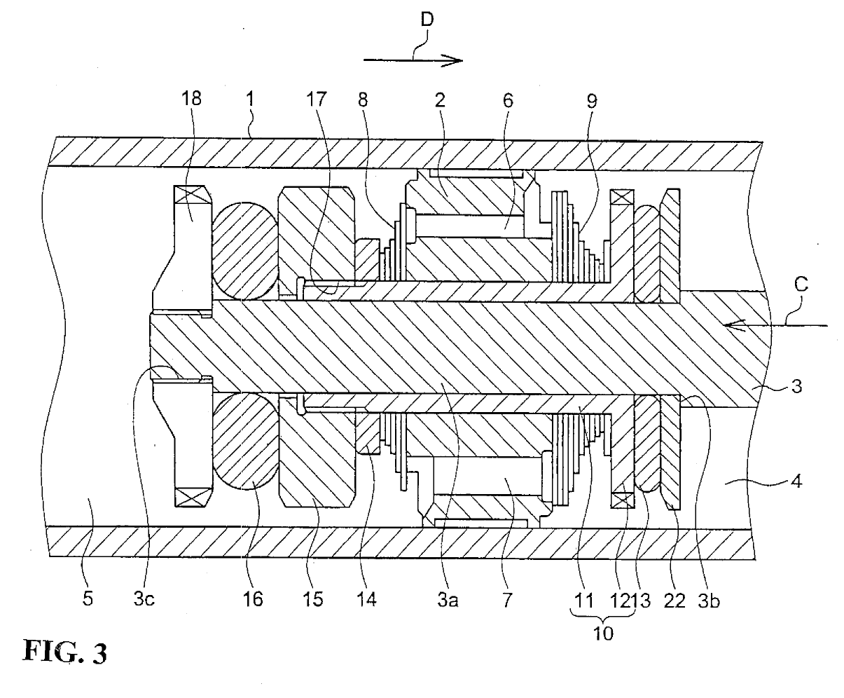

In the same manner, in a compression stroke, the piston rod 3 moves in the direction indicated by an arrow C in FIG. 3, oil in the counter-rod-side oil chamber 5 pushes away the pressure-side damping valve 9 to open the compression port 7, and the oil in the counter-rod-side oil chamber 5 flows out from the compression port 7 to the rod-side oil chamber 4. At this time, a pressure-side damping force is generated by the flowing resistance by the compression port 7 and the pressure-side damping valve 9.

Even though the opening of the pressure-side damping valve 9 is delayed by the instantaneous and impulsive input when the shock absorber is in action, the piston 2, the respective valves 8, 9 and the respective supports 14, 15 move in the direction indicated by an arrow D in FIG. 3 by the action of inertia according to the total mass thereof integrally with the supporting member 10 until the valve is opened to an adequate opening degree, and the flange 12 of the supporting member 10 compresses the first resilient member 13, so that an adequate reaction force is obtained by the first resilient member 13 and the ride quality of the vehicle is improved.

When the motorcycle is traveling, an impact caused by high-frequency vibrations enters the hydraulic buffering apparatus according to the state of the road surface. When the high-frequency vibrations are entered, the extension-side damping valve 8 and the pressure-side damping valve 9 might not generate an adequate damping force. However, in this case, the pressure-side damping valve 9, the piston 2, the extension-side damping valve 8, the first support 14 and the second support 15 reciprocate on the thin portion 3a of the piston rod 3 by the action of inertia according to the total mass of the respective members integrally with the supporting member 10, and hence finely vibrate thereon. Thereafter, as shown in FIG. 2 and FIG. 3, the supporting member 10 integrated with the respective members collides with the first resilient member 13 or the second resilient member 16 on both sides thereof in response to the high-frequency vibrations and compresses the same to obtain an adequate reaction force of the first resilient member 13 or the second resilient member 16.

In this embodiment, even when an impact caused by high-frequency vibrations is entered according to the state of the road surface during travel on the motorcycle, an adequate reaction force is obtained from the first resilient member 13 or the second resilient member 16, so that the ride quality of the vehicle is improved.

As described above, since the pressure-side damping valve 9, the piston 2, the extension-side damping valve 8, and the first support 14 are fitted on the shaft of the cylindrical portion 11 on the side of the inner surface of the flange 12 and the distal end of the cylindrical portion 11 which is penetrated through the first support 14 is connected to the inner periphery of the second support 15 via the thread, the respective members are integrally unitized.

Therefore, assembly of the respective members is achieved only by fitting the first stopper 22 and the first resilient member 13 onto the thin portion 3a, fitting the unitized supporting member 10 including the respective members unitized thereto, fitting the second resilient member 16 thereto, and then screwing the nut 18 onto the thread 3c at the distal end of the thin portion 3a, whereby the assembleability of the respective members is improved.

The present invention has been described on the basis of the embodiment. However, the present invention is not limited thereto. Although the extension-side damping valve 8 and the pressure-side damping valve 9 are configured by piling the plurality of leaf valves, they may be composed of one or two leaf valves.

Although the description has been given on the inverted hydraulic buffering apparatus in which the piston rod 3 is connected to the wheel side and the cylinder 1 is connected to the vehicle body side, the invention is also applicable to an erect type which is mounted upside down. Although the resilient members 13, 16 are formed of resilient rubber, they may be formed of either one of a disc spring, a bent washer, a wave washer or a coil spring.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A hydraulic buffering apparatus in which a piston is provided in a cylinder for partitioning an interior of the cylinder into a rod-side oil chamber on the side of a piston rod and a counter-rod-side oil chamber, the two oil chambers being in communication with each other via a pair of ports provided on the piston, and damping valves are provided respectively at exit ends of the pair of ports so as to be openable and closable, comprising:
a supporting member for holding the piston and the damping valves, said supporting member being slidably arranged on a shaft of the piston rod and held between stoppers provided on the shaft of the piston rod via resilient members.

2. The hydraulic buffering apparatus according to claim 1, wherein the supporting member includes a cylindrical portion to be fitted on the shaft of the piston rod, the cylindrical portion includes a flange at one end thereof, the outer surface of the flange comes into abutment with a first resilient member, and a first damping valve, the piston, a second damping valve, and a support of the second damping valve are arranged in sequence on a shaft of the cylindrical portion on the side of the inner surface of the flange so that the support is brought into abutment with a second resilient member.

3. The hydraulic buffering apparatus according to claim 2, wherein the support is formed on the inner peripheral portion thereof with a fitting hole to which the distal end of the cylindrical portion is fitted so as not to penetrate through the support, and the distal end of the cylindrical portion is fitted into the fitting hole.

4. The hydraulic buffering apparatus according to claim 1, wherein said damping valves includes an extension side damping valve and a pressure side damping valve each including a plurality of valve members with distinct outer diameters.

5. The hydraulic buffering apparatus according to claim 4, wherein the extension side damping valve and the pressure side damping valve are formed of leaf valves.

6. The hydraulic buffering apparatus according to claim 4, wherein said pair of ports includes an extension port and a compression port, said extension side damping valve being operatively positioned adjacent to said extension port, said pressure side damping valve being operatively positioned adjacent to said compression port.

7. The hydraulic buffering apparatus according to claim 1, wherein a distal end of the piston rod includes a thin portion and an enlarged portion with a shoulder formed therebetween, said supporting member including a cylindrical portion slidably mounted on the thin portion, said stopper including a first stopper disposed on said thin portion of said piston rod and being in engagement with said shoulder for limiting axial movement of the first stopper relative to the piston rod, said supporting member including a flange disposed at one end thereof in engagement with a first resilient member positioned between the flange and the first stopper.

8. The hydraulic buffering apparatus according to claim 1, wherein the support member includes a threaded distal end, a second support includes a fitting hole and is mounted to said threaded distal end via the threads, the second support is in abutment with a second resilient member held between the second support and a nut treaded to a distal end of the piston rod.

9. The hydraulic buffering apparatus according to claim 6, wherein when the piston rod is moved in an extension stroke, oil from the rod-side oil chamber imparts movement to the extension side damping valve to open the extension port and flows into the counter-rod-side oil chamber for generating an extension side damping force by the flowing resistance of the extension port and the extension side damping valve.

10. The hydraulic buffering apparatus according to claim 6, wherein when the piston rod is moved in a compression stroke, oil from the counter-rod-side oil chamber imparts movement to the pressure side damping valve to open the compression port and flows into the rod-side oil chamber for generating a pressure side damping force by the flowing resistance of the compression port and the pressure side damping valve.

11. A hydraulic buffering apparatus comprising:
a piston slidably mounted within a cylinder, said piston partitioning an interior of the cylinder into a rod-side oil chamber on the side of a piston rod and a counter-rod-side oil chamber;
a pair of ports provided on the piston, the two oil chambers being selectively in communication with each other via one of the ports;
damping valves operatively positioned relative to each exit ends of the pair of ports for opening and closing the ports; and
a supporting member for holding the piston and the damping valves, said supporting member being slidably arranged on a shaft of the piston rod and held between stoppers provided on the shaft of the piston rod via resilient members.

12. The hydraulic buffering apparatus according to claim 11, wherein the supporting member includes a cylindrical portion to be fitted on the shaft of the piston rod, the cylindrical portion includes a flange at one end thereof, the outer surface of the flange comes into abutment with a first resilient member, and a first damping valve, the piston, a second damping valve, and a support of the second damping valve are arranged in sequence on a shaft of the cylindrical portion on the side of the inner surface of the flange so that the support is brought into abutment with a second resilient member.

13. The hydraulic buffering apparatus according to claim 12, wherein the support is formed on the inner peripheral portion thereof with a fitting hole to which the distal end of the cylindrical portion is fitted so as not to penetrate through the support, and the distal end of the cylindrical portion is fitted into the fitting hole.

14. The hydraulic buffering apparatus according to claim 11, wherein said damping valves includes an extension side damping valve and a pressure side damping valve each including a plurality of valve members with distinct outer diameters.

15. The hydraulic buffering apparatus according to claim 14, wherein the extension side damping valve and the pressure side damping valve are formed of leaf valves.

16. The hydraulic buffering apparatus according to claim 14, wherein said pair of ports includes an extension port and a compression port, said extension side damping valve being operatively positioned adjacent to said extension port, said pressure side damping valve being operatively positioned adjacent to said compression port.

17. The hydraulic buffering apparatus according to claim 11, wherein a distal end of the piston rod includes a thin portion and an enlarged portion with a shoulder formed therebetween, said supporting member including a cylindrical portion slidably mounted on the thin portion, said stopper including a first stopper disposed on said thin portion of said piston rod and being in engagement with said shoulder for limiting axial movement of the first stopper relative to the piston rod, said supporting member including a flange disposed at one end thereof in engagement with a first resilient member positioned between the flange and the first stopper.

18. The hydraulic buffering apparatus according to claim 11, wherein the support member includes a threaded distal end, a second support includes a fitting hole and is mounted to said threaded distal end via the threads, the second support is in abutment with a second resilient member held between the second support and a nut treaded to a distal end of the piston rod.

19. The hydraulic buffering apparatus according to claim 16, wherein when the piston rod is moved in an extension stroke, oil from the rod-side oil chamber imparts movement to the extension side damping valve to open the extension port and flows into the counter-rod-side oil chamber for generating an extension side damping force by the flowing resistance of the extension port and the extension side damping valve.

20. The hydraulic buffering apparatus according to claim 16, wherein when the piston rod is moved in a compression stroke, oil from the counter-rod-side oil chamber imparts movement to the pressure side damping valve to open the compression port and flows into the rod-side oil chamber for generating a pressure side damping force by the flowing resistance of the compression port and the pressure side damping valve.
